(19) United States
(12) Patent Application Publication
(10) Pub. No.: US 2023/0388224 A1
(43) Pub. Date: Nov. 30, 2023

(54) Robust Network Path Generation

(71) Applicant: Google LLC, Mountain View, CA (US)

(72) Inventors: Ali Kemal Sinop, Fremont, CA (US); Sreenivas Gollapudi, Cupertino, CA (US); Konstantinos Kollias, San Jose, CA (US)

(21) Appl. No.: 17/886,764

(22) Filed: Aug. 12, 2022

(30) Foreign Application Priority Data
May 25, 2022 (GR) 20220100435

(51) Int. Cl. H04L 45/00; H04L 45/02

(52) U.S. Cl. CPC H04L 45/38; H04L 45/22; H04L 45/02

(57) ABSTRACT

Example aspects of the present disclosure provide for an example computer-implemented method for generating alternative network paths, the example method including obtaining a network graph; determining flows respectively for edges of the network graph by: resolving a linear system of weights associated with the edges, the linear system resolved over a reduced network graph, and propagating a solution of the linear system into a respective partition of a plurality of partitions of the network graph to determine at least one of the flows within the respective partition; and determining a plurality of alternative paths across the network graph.

### RELATED APPLICATIONS

This application claims priority to and the benefit of Greek Patent Application No. 20220100435, filed May 25, 2022. Greek Patent Application No. 20220100435 is hereby incorporated by reference herein in its entirety.

### FIELD

The present disclosure relates generally to determining network paths. More particularly, the present disclosure relates to generating one or more alternative network paths.

### BACKGROUND

The use of networked systems often involves traversing a route from a first point on the network to another point. For instance, in a computer network, data can be communicated over a route from a sender to a receiver. In a road network, vehicles can travel over a route from an origin to a destination. When determining a route for traversing a networked system, it may be desired to obtain alternatives. For instance, alternative routes can provide for accommodating user preference, system or other constraints, fault tolerance, etc.

### SUMMARY

Aspects and advantages of embodiments of the present disclosure will be set forth in part in the following description, or can be learned from the description, or can be learned through practice of the embodiments.

Example embodiments according to aspects of the present disclosure provide for an example computer-implemented method for generating alternative network paths. The example method can include obtaining a network graph. The example method can include determining flows respectively for edges of the network graph by: resolving a linear system of weights associated with the edges, the linear system resolved over a reduced network graph, and propagating a solution of the linear system into a respective partition of a plurality of partitions of the network graph to determine at least one of the flows within the respective partition. The example method can include determining, based on the flows, a plurality of alternative paths across the network graph.

Example embodiments according to aspects of the present disclosure provide for an example system for generating alternative network paths. The example system can include one or more processors and one or more memory devices storing non-transitory computer-readable instructions that are executable to cause the one or more processors to perform operations. In the example system, the operations can include obtaining a network graph including a plurality of nodes and a plurality of edges disposed therebetween. In the example system, the operations can include determining a plurality of reduced subgraphs respectively corresponding to a plurality of subgraphs of the network graph. In the example system, a respective reduced subgraph can include one or more boundary nodes of a respective subgraph. In the example system, the operations can include generating a plurality of interpolation transforms respectively for the plurality of subgraphs, a respective interpolation transform mapping demands on the one or more boundary nodes of the respective subgraph to internal nodes of the respective subgraph. In the example system, the operations can include obtaining a query indicating a load on the network graph corresponding to a source and a sink. In the example system, the operations can include determining, based on the load, an equivalent load on the plurality of reduced subgraphs. In the example system, the operations can include determining, based on flows induced in the plurality of reduced subgraphs by the equivalent load, a candidate subgraph of the network graph comprising a plurality of alternative paths.

Example embodiments according to aspects of the present disclosure can provide for one or more example memory devices storing computer-readable instructions that are executable to cause one or more processors to perform operations. In the example devices, the operations can include obtaining a query indicating a load on a network graph corresponding to a source and a sink. In the example devices, the operations can include determining, based on the load, an equivalent load on a plurality of reduced subgraphs. In the example devices, the operations can include determining, based on flows induced in the plurality of reduced subgraphs by the equivalent load, a candidate subgraph of the network graph including a plurality of alternative paths, wherein the flows are recovered using a plurality of interpolation transforms respectively associated with the plurality of reduced subgraphs.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example system for generating alternative network paths according to example aspects of some embodiments of the present disclosure;

FIG. 2 depicts a block diagram of an example system for generating alternative network paths according to example aspects of some embodiments of the present disclosure;

FIG. 3A depicts a diagram of an example technique for generating alternative network paths according to example aspects of some embodiments of the present disclosure;

FIG. 3B depicts a diagram of an example technique for generating alternative network paths according to example aspects of some embodiments of the present disclosure;

FIG. 4 depicts example results for benchmark comparisons for an example system for generating alternative network paths according to example aspects of some embodiments of the present disclosure;

FIG. 5 depicts example results for benchmark comparisons for an example system for generating alternative network paths according to example aspects of some embodiments of the present disclosure;

FIG. 6 depicts example results for benchmark comparisons for an example system for generating alternative network paths according to example aspects of some embodiments of the present disclosure;

FIG. 7 depicts example results for benchmark comparisons for an example system for generating alternative network paths according to example aspects of some embodiments of the present disclosure;

FIG. 8 depicts example results for benchmark comparisons for an example system for generating alternative network paths according to example aspects of some embodiments of the present disclosure;

FIG. 9 depicts example results for benchmark comparisons for an example system for generating alternative network paths according to example aspects of some embodiments of the present disclosure;

FIG. 10A depicts a block diagram of an example computing system that performs generating alternative network paths according to example aspects of some embodiments of the present disclosure;

FIG. 10B depicts a block diagram of an example computing device that performs generating alternative network paths according to example aspects of some embodiments of the present disclosure;

FIG. 10C depicts a block diagram of an example computing device that performs generating alternative network paths according to example aspects of some embodiments of the present disclosure; and

FIG. 11 depicts a flow chart diagram of an example method to perform generating alternative network paths according to example aspects of some embodiments of the present disclosure.

Reference numerals that are repeated across plural figures are intended to identify the same features in various implementations.

### DETAILED DESCRIPTION

### Overview

Generally, the present disclosure is directed to techniques for generating alternative paths across a networked system. For instance, a network graph can be weighted, and candidate paths can be determined based on the weights of segments along the path. Example embodiments according to the present disclosure can generate alternatives by employing a linear estimation of flows across the network. Furthermore, example embodiments can provide for resolving a set of alternatives by carefully partitioning the network graph and resolving the linear estimation over one or more reduced subgraph(s), using interpolation transforms to recover flow(s) within the original network graph. In some examples, the interpolation transforms can be precomputed to speed up the generation of alternatives at runtime.

Example embodiments according to the present disclosure provide for generating alternate routes or paths across a road network. For instance, a road system can contain a network of interconnected roadways. Example techniques described herein can provide for generating a set of robust alternative routes for traversing the road system from an origin to a destination. For example, a robust set of alternative routes can accommodate faults or deficiencies of a given route (e.g., road closure, traffic jam, construction zone, etc.) by providing suitably diverse alternative routes that are not subject to the same fault or deficiency.

Some prior techniques for obtaining alternative routes across a networked system exhibit various shortcomings. For example, the plateau method is a prior technique that searches over two tree structures—one shortest-path tree built from the origin and one shortest-path tree built from the destination—to find shared segment sequences that form a waypoint (“via node”) for generating one or more candidate alternatives. But the plateau technique generally tends to generate alternatives that lack robustness, as the alternatives tend to exhibit high degrees of similarity, such that a critical fault in the network affecting one alternative has a high probability of affecting one or more other alternatives. In another example, the penalty method is a prior technique that generally involves a brute-force iteration over a weighted network graph: after an optimal candidate path is obtained (e.g., lowest weight), its segments are re-weighted (e.g., penalized) and the search is executed again over the graph. While the penalty method can in some cases generate quality results, it can be extremely computationally expensive, rendering it often cost-prohibitive or impracticable for runtime applications (e.g., due to latency, etc.).

Advantageously, example embodiments according to aspects of the present disclosure can provide for the determination of a robust set of alternative routes in a more computationally efficient manner. For instance, example embodiments of the present disclosure can execute an adapted electrical flow analysis to resolve component loads for determining alternate paths. For instance, in the context of a road network, a weight or “conductance” can be assigned to a road segment for determining the amount of traffic flow or “current” given an amount of traffic demand or “potential.” In this manner, for instance, linear circuit analysis techniques (e.g., Kirchhoff s Law, Ohm's Law, etc.) can be leveraged in a new domain to evaluate the traffic flows across road segments in a road network. For instance, the road network graph can be constructed as a linear system (e.g., in the form of a Laplacian matrix, etc.).

Additionally, example embodiments of the present disclosure also provide for resolving the set of alternative paths by operating over a simplified network partitioned based on network bottlenecks. For example, many real-world networked systems can include primary thoroughfares or other segments that provide a primary point of access between areas of the network. For instance, a road network can have primary interstate highways, bridges, or other road segments that concentrate flow across borders (e.g., into a city, into a state, into a region, etc.). By partitioning the network graph such that partition boundaries cut edges connecting these bottlenecks, a simplified or reduced network graph can be formed from the cut edges. The subgraphs within the partitions can also be reduced (e.g., using star-mesh transforms, Gaussian elimination, etc.), such that the remaining graph nodes correspond to the bottlenecks. This reduced graph can provide for rapid identification of, at a high level, the edges (and associated bottlenecks) through which optimal candidate paths may pass. After resolution of the reduced graph, the initial solution can be propagated into the partitions to interpolate from the bottleneck(s) to interior nodes of the partitions.

Additionally, in some embodiments, the initial solution can be propagated into the partitions using precomputed interpolation transforms. For instance, the interpolation transforms can be precomputed when the network graph is partitioned. For instance, a preprocessor can receive a network graph, generate the partitions, and determine the interpolation transforms for the partitions.

In some embodiments, a query received at runtime can include an origin and a destination. A path searcher according to the present disclosure can “load” the network graph (e.g., the reduced network graph) with potentials (e.g., a source and sink) to resolve the induced flows and determine a set of alternative paths that correspond to the optimal flow paths. Advantageously, the set of alternative paths can exhibit robustness to network faults while being efficiently computed.

Example embodiments of the present disclosure can provide for a number of technical effects and benefits. For instance, networked systems can route network traffic more reliably by generating a robust set of alternative paths. For instance, a computer network (e.g., a telecommunications network) can efficiently obtain a set of robust alternative network routes that can exhibit improved robustness toward network faults (e.g., inoperative transceivers, severed communication wires, damaged fiber optics, etc.). For instance, a map routing system (e.g., for generating routes over transportation networks, such as roadways, bike paths, pedestrian paths, public transportation infrastructure, etc.) can more efficiently generate more robust routes for directing traffic with lower latency, using fewer computing resources, etc. By more efficiently resolving flows over a loaded network graph, an alternative path generator according to the present disclosure can be executed in resource-constrained implementations (e.g., on mobile devices, low-power computing devices, onboard vehicle computing systems, etc.). Additionally, or alternatively, by more efficiently resolving flows over a loaded network graph, an alternative path generator according to the present disclosure can generate alternatives faster for a given set of computational resources, providing for decreased latency in runtime generation of alternative routes.

Furthermore, in some embodiments, precomputing one or more components used at runtime to resolve alternative paths (e.g., an interpolation transform) can reduce repeated computation. For instance, in some embodiments, an alternative path generator according to aspects of the present disclosure can perform preprocessing to precompute one or more solution components. For instance, preprocessing can be performed as an initialization procedure for a new or updated network graph. Subsequently, at runtime a path searcher can leverage the precomputed components for executing multiple queries over the network graph, reaping efficiency gains with each runtime query by not needing to recompute the precomputed components. In this manner, for example, implementations according to example aspects of the present disclosure can provide for decreased computation resource usage (e.g., memory, processor bandwidth, etc.) when processing runtime queries.

Although aspects of the present disclosure are discussed in the context of a road network, it is to be understood that network graphs can be processed according to the present disclosure for a variety of networked systems. For instance, a network can include a road network, an electrical grid or network, a wireless communication network (e.g., local area network, wide area network), a cellular communication network (e.g., 2G, 3G, 4G, 5G, etc.), a logistics network, a utilities network (e.g., water, gas, electricity, etc.), a transportation network (e.g., ground based, air based, etc.), and the like.

With reference now to the Figures, example embodiments of the present disclosure will be discussed in further detail.

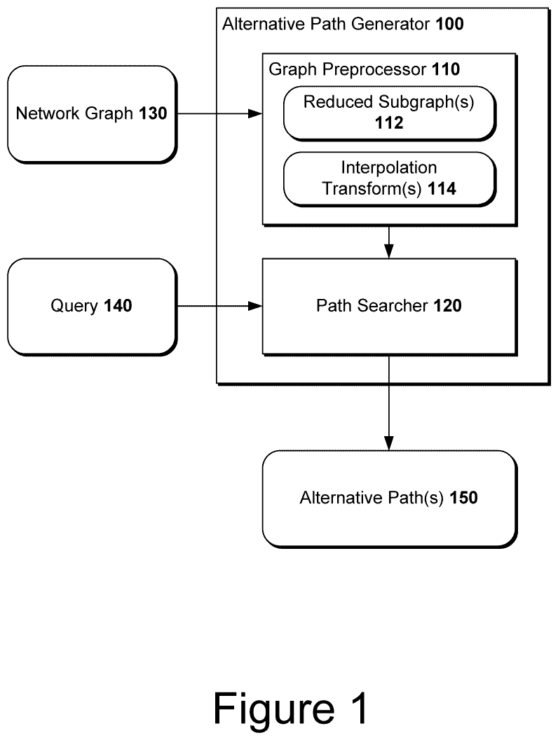

FIG. 1 depicts a block diagram of an example implementation of an alternative path generator 100 according to example aspects of the present disclosure. The alternative path generator 100 can include a graph preprocessor 110 and a path searcher 120. The preprocessor 110 can preprocess the network graph 130 to generate one or more reduced subgraph(s) 112 and interpolation transform(s) 114. The path searcher 120 can receive data descriptive of a query 140 and use one or more outputs of the graph preprocessor 110 to generate alternative path(s) 150.

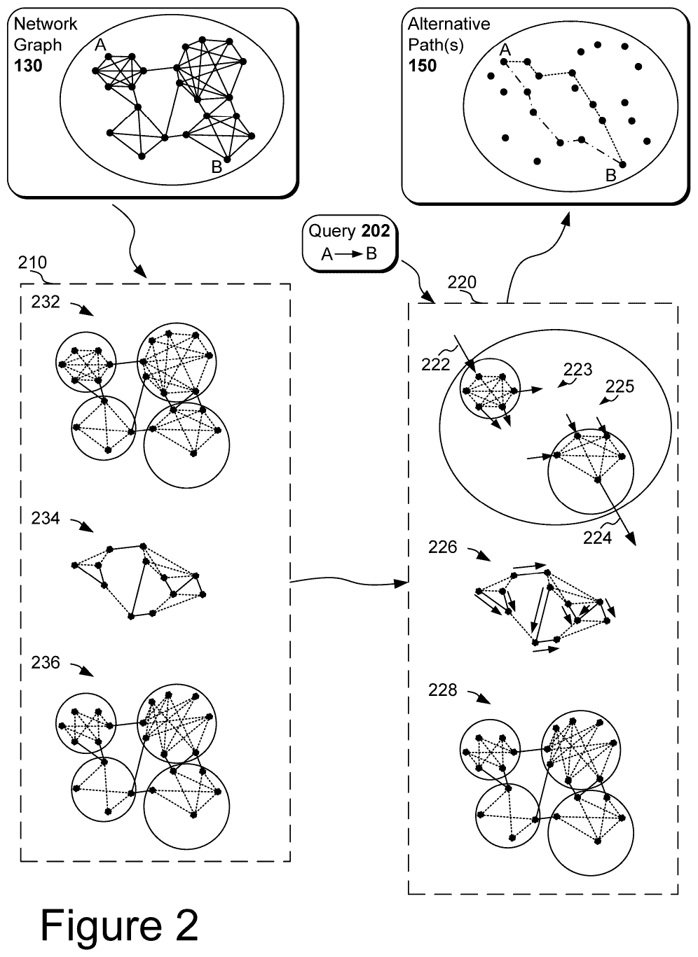

In some embodiments, for example, the network graph 130 can include one or more graph structures (e.g., nodes, edges intersecting one or more nodes, etc.). For example, the network graph 130 can include a weighted graph structure having weights assigned to one or more edges or one or more nodes. For instance, in some embodiments, a node can be representative of a junction (e.g., a roadway intersection, network connection, transfer station, etc.). In some embodiments, an edge can be a representation of a network segment (e.g., roadway segment, network line/cable/fiber, transportation route, etc.). In some embodiments, the network graph can be representative of a graph neural network. In some embodiments, one or more weight(s) corresponding to an edge or node can be determined to represent one or more characteristic(s) of the edge or node. For instance, a weight can be based on a flow parameter for the edge or node, such as a parameter based on historical or projected flow data. For instance, in the context of a roadway network, the weight(s) can be based on historical or predicted traffic data, lane count, speed limit, etc. An example network graph 130 is illustrated in FIG. 2.

In some embodiments, for example, the graph preprocessor 110 can generate one or more reduced subgraph(s) 112 based on the network graph 130. For instance, the network graph 130 can be analyzed to determine one or more bottlenecks (e.g., bottleneck nodes, bottleneck edges, etc.). In some embodiments, bottlenecks can be determined by edges or nodes having high flows associated therewith. In some embodiments, bottlenecks can be determined using a bidirectional Dijkstra search. In some embodiments, bottlenecks can be determined based on tags or labels associated with the network graph 130 (e.g., tagged bridges, tagged interstates, etc.). In some embodiments, bottlenecks can be predicted or inferred by a machine-learned model trained to determine network bottlenecks (e.g., trained using supervised learning, unsupervised learning, etc.). In some embodiments, bottleneck determination can be learned as part of end-to-end training of the preprocessor 112 for optimal subgraph reduction.

An example preprocessing flow 210 is illustrated in FIG. 2 with an example partitioned network graph 232. The solid edges in partitioned network graph 232 illustrate example bottleneck edges between bottleneck nodes, and the dotted edges illustrate connections to internal, non-bottleneck nodes.

In some embodiments, for example, the reduced subgraphs 112 can be generated by partitioning the network graph 130 such that the bottlenecks lie on the boundaries of the partitions. In this manner, for example, the boundaries of the partitions can cut bottleneck edges. In this manner, for instance, a reduced network graph can be formed that maps the relationships between the bottlenecks. To form the reduced network graph, non-bottleneck nodes can be eliminated (e.g., by star-mesh transform, by Gaussian elimination, etc.) and replaced by equivalent connections directly between the bottleneck nodes. In this manner, for instance, the reduced subgraphs 112 can be effectively equivalent from a flow/load perspective on the boundaries as compared to the original partitions. In this manner, furthermore, the reduced subgraphs 112 can be equivalent subgraphs that collectively comprise the reduced network graph mapping the cut edges.

An example reduced network graph 234 is illustrated in FIG. 2 within the example preprocessing flow 210. The solid edges in reduced network graph 234 illustrate example bottleneck edges between bottleneck nodes, and the dotted edges illustrate the reduced connections (e.g., based on a star-mesh transform) interconnecting the bottleneck nodes.

In some embodiments, for example, one or more interpolation transforms 114 can be determined to provide a mapping between the reduced subgraphs 112 and the partitions on which they are based. For instance, the interpolation transforms 114 can provide for propagation of a flow, load, or demand on a bottleneck (e.g., on the boundary of a partition) through the internal connections of the partition. For instance, once flows over the reduced network graph are obtained, the flows on the bottleneck nodes (e.g., the nodes of the reduced network graph) can be propagated into or interpolated within the original partitions based on the interpolation transforms 114 to recover individual flows on the original structures.

An example of a propagation diagram 236 is illustrated in FIG. 2 within the example preprocessing flow 210. The solid edges in the propagation diagram 236 illustrate example bottleneck edges between bottleneck nodes, and the dotted edges illustrate the propagation pathways (e.g., based on interpolation transforms 114) connecting the bottleneck nodes to the original internal nodes of the partitions of the network graph 130.

In some embodiments, for example, a path searcher 120 can process a query over the network graph 130 by leveraging one or more outputs from a preprocessor (e.g., preprocessor 110). For example, the query can indicate a request for one or more paths from points on the network graph 130. The points can be descriptive of an origin or a destination, or one or more waypoints therebetween. In some embodiments, the query can indicate a request for a quantity of alternatives or otherwise specify one or more characteristics of the set of alternatives.

An example path search algorithm 220 is illustrated in FIG. 2. The query 202 can contain a request for one or more paths connecting point A to point B on the network graph 130. At point A, the path searcher 120 can inject a load or demand 222 on the network graph partition containing point A. In some aspects, this load 222 can be considered a “potential” (e.g., by way of analogy to an electrical potential). At point B, the path searcher 120 can inject a load or demand 224 on the network graph partition containing point B. In some aspects, this load 224 can be considered a potential, such as a potential of opposite polarity or lesser magnitude as that of load 222. For instance, load 222 can be a source and load 224 can be a sink, such that flow is induced across the network graph 130.

In some embodiments, for example, the induced flow across the network can be transformed from the initial loads 222 and 224 to be resolved on the bottleneck nodes on the boundaries of the respective partitions. For instance, the bottleneck loads 223 can be resolved using one or more circuit analysis techniques to map the source load 222 to the corresponding bottleneck nodes (e.g., by solution of a linear system descriptive of “flows” induced in the network). Similarly, the bottleneck loads 225 can be resolved using one or more circuit analysis techniques to map the sink load 224 to the corresponding bottleneck nodes.

In some embodiments, for example, the reduced network graph 234 (e.g., obtained by the preprocessor 120) can be subjected to the bottleneck loads 223 and 225 to resolve the flows and loads over and through the bottlenecks. In this manner, for example, an intermediate solution 226 can be obtained that maps induced loads/flows over the reduced network graph 234 at a partition-level precision. In some embodiments, the intermediate solution 226 can be used to prune the network graph 130 (e.g., one or more partitions thereof).

In some embodiments, for example, the intermediate solution 226 over the reduced network graph 234 can be propagated out from the bottlenecks to other original nodes/segments of the network graph 130 (e.g., partitions thereof). For instance, the interpolation transforms 114 can be used at 228 to propagate the intermediate solution 226 into the original components.

In some embodiments, the demands and induced flows that are resolved over the network graph 130 (e.g., one or more partitions thereof) can be used to determine alternative path(s) 150. In some embodiments, candidate paths for the alternatives 150 can be determined based on an optimal flow (e.g., highest flow at a point, highest average flow, highest minimum flow, etc.). In some embodiments, determining an optimal flow can include a Dijkstra for a maximum minimum flow path selection. In some embodiments, during the Dijkstra, if a node under consideration only has a single outgoing edge, the edge can be followed until an already-visited node is hit (since the flow on the outgoing edge is generally not less than the incoming edge, such can be indicative of the max-min flow path to each of the nodes visit along the way). In some embodiments, one or more candidate paths can be determined iteratively. For instance, in some embodiments, an optimal candidate path can be determined along a highest minimum-flow route. The flow corresponding to that path can be removed from the network (e.g., using flow decomposition), and the next-best candidate can be obtained. In this manner, for example, multiple alternatives can be iteratively generated.

In some embodiments, the alternative path(s) 150 can be obtained by performing a penalty search over a strategically pruned subgraph. For instance, in some embodiments, the path searcher 120 can perform the techniques of the present disclosure to quickly resolve flows across a network graph 130, and by doing so identify a subset of partitions of the network graph that correspond to the portions of the network 130 that, based on the intermediate solution, will likely contain one or more good alternative paths (e.g., based on the throughput of the bottlenecks connected therebetween). For example, the pruned subgraph can be pruned by discarding edges with negative flow, or by discarding edges having less than a threshold amount of flow, etc. Furthermore, the resulting graph can be compressed by “shortcutting” nodes that have an in-degree/out-degree of 1 (e.g., treating as one edge, etc.).

In some embodiments, generation of sets of alternative paths can be performed in a hierarchical fashion. For instance, in some embodiments, partitioning can occur over multiple spatial scales, and graph reduction (e.g., node elimination) can occur over multiple scales. For instance, for routes across a large network graph (e.g., a map of an entire continent) the partitioning at the highest level can be larger, to provide initial pruning of partitions of large portions of the network before propagating the solution to more granular levels.

### Example Algorithms

Example algorithms are presented herein for illustrative purposes only. It is to be understood that various configuration selections of the example embodiments described herein with respect to the example algorithms are presented for the purpose of illustration and not by way of limitation.

For the present example, let G=(V,E) be an undirected, simple graph on n nodes and m edges (oriented arbitrarily) with non-negative weights w: E→ [symbol] ₊ on its edges (e.g., the weights representing distances, costs of traversing the edge, etc.). In this example, G is assumed to be connected. For a given subset of nodes S⊆V, let G[S] denote the subgraph induced in G by S. For a node s, let N(s) denote its neighbors. Although G here is described as an undirected graph in the present example for the sake of simplicity, it is to be understood that G can be a directed graph.

For the present example, let f∈ [symbol] ^{E} denote a flow on G as a function of the edges of G such that, on any edge e=(u,v), fₑ equals the net flow from u toward v (e.g., which might be negative if the flow is from v toward u). For such an edge e, let the flow notation be f_{u→v}:=f_{(u,v)} and f_{v→u}:=f_{(u,v)}. For this example, let the flows be circulation-free (e.g., the sum of flows around any cycle is zero). For this example, a flow is a unit flow from a source s to a terminus or sink t if: the net flow on s is 1, Σ_{u∈N(s)} f_{s→u}=1; the net flow on t is −1, Σ_{u∈N(t)}f_{s→u}=−1; the net flow is 0 on any other node v, Σ_{u∈N(v)}f_{v→u}=0. In this example, any path p between s and t naturally corresponds to a flow, with the flow value on e being +1 if (u,v)∈p, −1 if (u,v)∈p and 0 otherwise.

In the present example, any circulation-free unit flow f from s to t can be written as a convex combination of paths from s to t, in which all paths have the same direction of flow on every edge and f=Σ_{p∈} [symbol] _{ₛₜ}αₚfₚ for some non-negative values αₚ which sum up to 1. Here [symbol] ₛₜ is the set of simple paths from s to t and fₚ is the flow corresponding to path p. While the choice of α may not necessarily be unique, it can generally be possible to decompose a unit flow into a convex combination of paths.

In the present example, rows and columns of vectors and matrices can be associated with sets. For instance, x∈ [symbol] ^{A} can denote a vector whose rows correspond to the set A. For any B⊆A, let x∈ [symbol] ^{B} can denote the restriction of x to B. Similarly, M∈ [symbol] ^{A×B} can denote a matrix whose rows and columns are associated with the sets A and B, respectively. For any C⊆A, D⊆B, let M_{C,D}∈ [symbol] ^{C×D} denote the minor of M corresponding to rows C and columns D. In the present example, M^{T}, M⁻¹, and M^{†} to denote the transpose, inverse, and (if not invertible) pseudo-inverse of M, respectively.

In the present example, flows induced over the network graph can be obtained by simulating the network as an electrical system. For instance, the conductance matrix C∈ [symbol] ^{E×E}, as the diagonal matrix that has the “conductance” of each edge along its diagonal. In particular, in the present examle,

$${C}_{e , e} = \frac{1}{{w}_{e}} .$$

In the present example, let B∈ [symbol] ^{E×V} denote the signed edge-node incidence matrix of G. Each row of B is associated with an edge e∈E, and each column of B is associated with a node v∈V. For any edge e=(u,v)∈E and x∈V, the corresponding entry in B can be given as: B_{e,x}=1 if x=B_{e,x}=−1 if x=v; and 0 if else.

In the present example, the discrete gradient operator on G can be expressed as ∇_{G}∈ [symbol] ^{E×V}, as ∇_{G}:=CB. In this example, ∇_{G} sends functions on V to functions on the edge set, E. In particular, for any vector on nodes x∈ [symbol] ^{V} and any edge

$$e = ( u , v ) ∈ E , {( {∇}_{G} x )}_{e} = \frac{1}{{w}_{uv}} ( {x}_{u} - {x}_{v} ) .$$

Similarly, B^{T} can be viewed as a discrete divergence operator: given any flow f∈ [symbol] ^{E}, B^{T}f can measure the net flow on each node. For example, if f is a unit flow from s to t, then B^{T}f=χₛ−χₜ, where χₛ is the indicator vector for node s. Let Δ_{G}∈ [symbol] ^{V×E} denote this matrix, Δ_{G}=B_{G}^{T}.

In the present example, the Laplacian matrix L associated with G can be expressed as L_{G}=Δ_{G}∇_{G}. For any vector x∈ [symbol] ^{V} the quantity x^{T}Lx=Σ_{(u,v)∈E}wᵤᵥ⁻¹(xᵤ−xᵥ)² measures, by way of analogy, the energy dissipated by the electrical resistances of the network G if the potential at each node was equal to x. In this example, the rank of L is equal to n−1 with its null space consisting of an all 1 vector. Therefore, for any vector y∈ [symbol] ^{V} which is orthogonal to the all 1 vector (b⊥1), Lx=y has a solution. The system can be resolved in the form Lx=b.

In the present example, by way of analogy, the network graph (e.g., graph 130) can be viewed as a network of wires having resistance wₑ and the nodes as connection points of wires. If ϕ∈ [symbol] ^{V} is a vector of potentials, then Ohm's law provides that electrical flow is provided f=∇ϕ with the corresponding demand being Δf=Δ∇ϕ=Lϕ. Thus, in the present example, the vector of node potentials that induce a unit flow from s to t can be given by ϕ^{st}=L^{†}(χₛ−χₜ). Consequently, the electrical flow from s to t is given by f=∇ϕ^{st}. For example, the flow on an edge (u,v) is given by

$${f}_{( u , v )} = \frac{1}{{w}_{u , v}} ( {ϕ}^{s t} ( u ) - {ϕ}^{s t} ( v ) ) = {( {χ}_{u} - {χ}_{v} )}^{T} ∇ {L}^{†} ( {χ}_{s} - {χ}_{t} ) \qquad ( 1 )$$

In the present example, the effective resistance, by way of analogy, can be expressed as

$${R}_{eff} ( s , t ) = {( {ϕ}^{s t} )}^{T} L {ϕ}^{s t} = {( {χ}_{u} - {χ}_{v} )}^{T} ∇ {L}^{†} ( {χ}_{s} - {χ}_{t} ) = {ϕ}^{s t} ( s ) - {ϕ}^{s t} ( t ) \qquad ( 2 )$$

from which it can be seen that

$${R}_{eff} ( s , t ) = {\sum }_{e} {w}_{e} {f}_{e}^{2} = {f}^{T} {C}^{- 1} . \qquad ( 3 )$$

In the present example, by way of analogy, the effective resistance R_{eff}(s,t) and the electrical flow f from s to t as the optimum value and solution of min(Σₑwₑfₑ²) subject to Δf=χₛ−χₜ. In this example analytical framework, a shortest-path problem corresponds to minimizing an l₁ norm of f, and a maximum flow problem corresponds to minimizing an l_{∞} norm of f. In some scenarios, an l₁ norm can perform better with sparse solutions, leading to diminished robusticity in some less sparse solutions. In some scenarios, an l_{∞} norm can provide for well-spread paths with improved robustness, albeit without necessarily guaranteeing a length metric. In some examples, optimizing an l₂ norm (e.g., minimizing) can effectively combine aspects of each, providing for short and diverse paths.

In the present example, preprocessing can be performed to reduce the graph size, such that the flow analysis can be performed over a smaller graph. In this example Schur complements can be used to implement Gaussian elimination over whole blocks at the same time. For example, given a symmetric block matrix

$$M = [ \begin{matrix}A & B \\ {B}^{T} & C\end{matrix} ] \qquad ( 4 )$$

and if C is invertible, then the Shur complement of C, M/C can be given by A−BC⁻¹B^{T}. It is known that Schur complements are commutative (changing the order of complements yields the same matrix) and they are closed for Laplacian matrices (any Schur complement of a Laplacian matrix is Laplacian). If L is a Laplacian matrix, and A is a subset of nodes, let L/A be shorthand notation for the Schur complement of the principal minor corresponding to A in L.

In the present example, the network graph can be partitioned into balanced components, and Schur complements of each component can be determined. The flow analysis can be performed over the smaller graph, and the solution can be propagated to the rest of the graph (or a pruned version thereof). For example, a preprocessor (e.g., preprocessor 110) can partition the graph G into k disjoint components, [symbol] ={C₁, C₂, . . . , Cₖ}, so that V(G)=UᵢCᵢ. For each component C∈ [symbol] , let ∂C and int(C) to refer to its boundary and interior nodes, respectively. Let int(C) be the set of nodes whose neighbors are all inside C such that int(C):={u∈C:N(u)⊆C} and ∂C:=C int(C). Let ∂ [symbol] and int( [symbol] ) denote the set of all boundary and interior nodes. In some examples, the partitioning can be optimized toward each component in C∈ [symbol] being balanced, in the sense that |C|=Θ(n/k), with the induced subgraph G[C] is connected, and further optimized toward each component cutting few edges, such that E|C,C̅|≤O(|C|^{γ}) for some γ≤½. In some examples, road networks can have partitioning with γ→⅓ and one can find such partitioning relatively efficiently (e.g., based on main transportation arteries, etc.).

In the present example, by way of analogy, the electrical flow can be found on the induced subgraph G [OP]. Then the divergence of the flow on the boundary nodes can be formulated as demands for that respective component. The electrical flow can be resolved using the demands on each component. Without external demands for the respective component, the electrical flow computation can be expressed as a matrix multiplication, with a matrix of size number of interior nodes-by-number of boundary nodes, which can be precomputed beforehand. For an intuition behind the computation of G [∂ [symbol] ], a single component C can be considered. The node potentials can be obtained from the solution of Lϕ=d, where d is the demands vector d=χₛ−χₜ. U can denote the rest of the nodes, U=V\C, and the corresponding block in the Laplacian matrix L_{int(C),U}=0. Thus, the linear system can be expressed as

$$[ \begin{matrix}{L}_{U , U} & {L}_{U , \partial C} & 0 \\ {L}_{\partial C , U} & {L}_{\partial C , \partial C} & {L}_{\partial C , int ( C )} \\ 0 & {L}_{i n t ( C ) , \partial C} & {L}_{int ( C ) , int ( C )}\end{matrix} ] [ \begin{matrix}{ϕ}_{U} \\ {ϕ}_{\partial C} \\ {ϕ}_{i n t ( C )}\end{matrix} ] = [ \begin{matrix}{d}_{U} \\ {d}_{\partial C} \\ {d}_{int ( C )}\end{matrix} ] \qquad ( 5 )$$

Let Y:=L_{∂C,int(C)}L_{int(C),int(C)}⁻¹. If multiplied on the left by

$$[ \begin{matrix}I & 0 & 0 \\ 0 & I & - Y \\ 0 & 0 & I\end{matrix} ] \qquad ( 6 )$$

then the top two rows of Equation (5) become

$$[ \begin{matrix}{L}_{U , U} & {L}_{U , \partial C} & 0 \\ {L}_{\partial C , U} & {L}_{\partial C , \partial C} - {L}_{\partial C , int ( C )} Y & 0\end{matrix} ] [ \begin{matrix}{ϕ}_{U} \\ {ϕ}_{\partial C}\end{matrix} ] = [ \begin{matrix}{d}_{U} \\ {d}_{\partial C} - {Yd}_{int ( C )}\end{matrix} ] \qquad ( 7 )$$

of which let \hat{L} be the top-left 2×2 block of the left-hand side matrix of Equation (7), which forms the Schur complement of int(C), such that \hat{L} is itself a Laplacian matrix. Thus, the problem can be reduced to finding potentials on V′:=U∪∂C, with the new demands

$${d}^{r} := [ \begin{matrix}{d}_{U} \\ {d}_{\partial C} - {Yd}_{int ( C )}\end{matrix} ] . \qquad ( 8 )$$

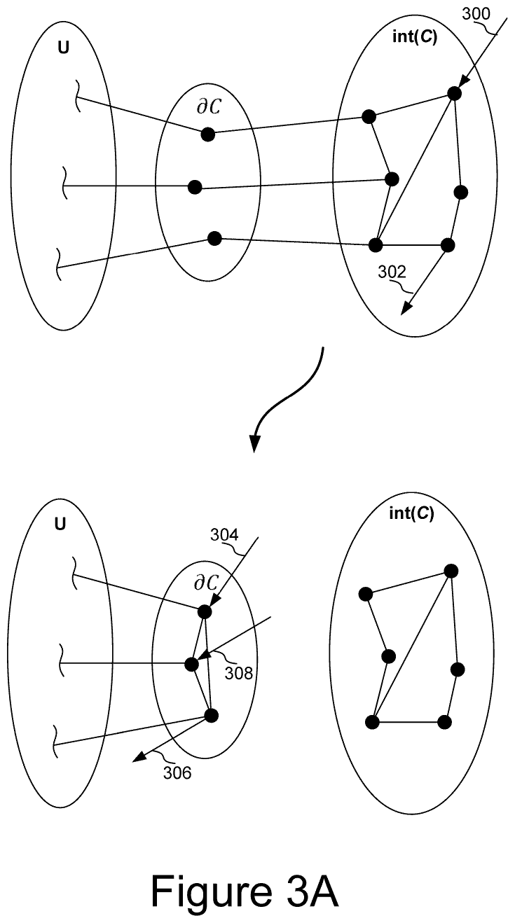

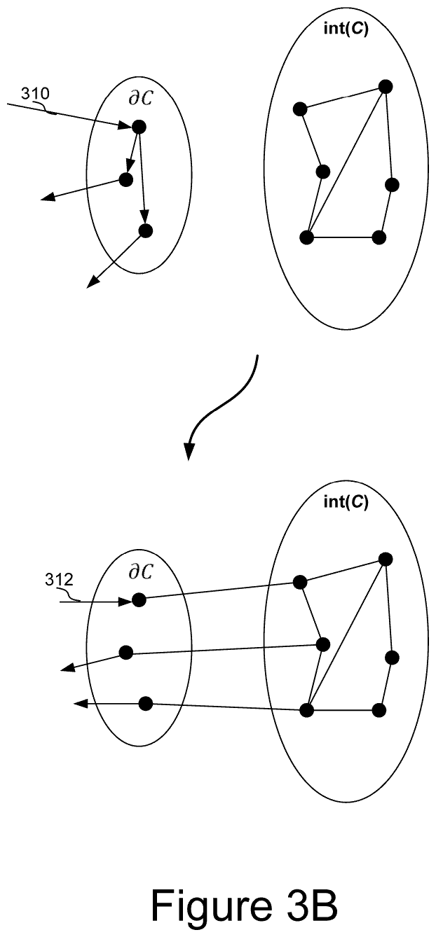

In this manner, for instance, Y can form an interpolation transform for transferring the demands from int(C) to ∂C. For instance, FIG. 3a illustrates demands 300 and 302 on int(C) being mapped to demands 304, 308, and 306 on ∂C using the transform Y (note, e.g., new equivalent connections formed in ∂C).

In the present example, supposing a solution is obtained for the potentials over the reduced graph (e.g., of the form \hat{L}ϕ^{r}=d^{r}), ϕ^{r} can be used to compute the flows on the edges of G[V′],E^{b}, which can be unaffected by magnitude shifts. The flow on the remaining edges, Eⁱ, which are the edges incident to the interior nodes, int(C), can be obtained using flow conservation. Based on flow conservation, the net flow on a boundary node u∈∂C due to the edges from E^{b} is met by the net flow on the edges of Eⁱ plus the initial demand dᵤ. This gives a new set of demands d′ on C, and the flow on edges Eⁱ should satisfy the electrical flow equations with respect to these demands. FIG. 3b illustrates how the flows 310 on the boundary edges are transformed using an interpolation transform to demands 312 on the boundary nodes.

In the present example, for instance, let [symbol] be the graph G[C] with edges between ∂C removed, then the flow on the edge of [symbol] will be equal to [symbol] . ϕ_{C} where ϕ_{C} is the potentials in [symbol] with respect to demands d′. Thus, the system [symbol] ϕ_{C}=d′ can be solved (where [symbol] is the Laplacian of [symbol] ).

In the present example, it can be expressed that, given a Laplacian matrix L∈ [symbol] ^{V×V} of a connected graph and a vector of demands d∈ [symbol] ^{V} with support S, the corresponding electrical flow can be given by

$$∇ \cdot [ \begin{matrix}I \\ - {L}_{U , U}^{- 1} {L}_{U , S}\end{matrix} ] {( L / U )}^{†} {d}_{S} \qquad ( 9 )$$

where U:=V\S and L/U is the Schur complement of U. Accordingly, when d′_{int(C)}=0, an interpolation transform X can be obtained to map the demands on the boundary to a potential vector ϕ_{C}=Xd_{∂c}, whose gradient gives the electrical flow on [symbol] , where

$$X := [ \begin{matrix}I \\ - {ℒ}_{int ( C ) , int ( C )}^{- 1} {ℒ}_{int ( C ) , \partial C}\end{matrix} ] {( ℒ / int ( C ) )}^{†} \qquad ( 10 )$$

which, like Y, can be precomputed and reused.

In the present example, the above example algorithm can be repeated for each component C, each time eliminating that component's interior nodes and updating the reduced demands d^{r} to arrive at a linear system \hat{L}ϕ^{r}=d^{r} which can be solved (e.g., by a Laplacian solver). Additionally, \hat{L}, X, and Y can be precomputed and reused.

In some embodiments, an example implementation can follow one or more of Algorithms 1, 2, and 3.

Algorithm 1: PREPROCESS-GRAPH(G, [symbol] )

input :Weighted graph G and its partitioning [symbol] .
output:\hat{L} ∈ [symbol] (Schur Complement of the interior),
X ∈ [symbol] (harmonic interpolation matrix).
\hat{L} ← Laplacian matrix on ∂ [symbol] (initially 0).
Add all edges cut by [symbol] to \hat{L}.
foreach C ∈ [symbol] do

| | |
|---|---|
| \| | B ← ∂C, I ← int(C). |
| \| | H ← G[C], L ← Laplacian of H. |
| \| | \hat{L}_{B,B} ← \hat{L}_{B,B} + L_{B,B} − L_{B,J}L_{I,I}⁻¹L_{I,B}. |
| \| | [symbol] ← H with all edges between B removed. |
| \| | [symbol] ← Laplacian of [symbol] . |
| \| | U ← [symbol] _{I,I}⁻¹ [symbol] _{I,B}. |
| \| | X_{B,B} ← [symbol] _{B,B} − [symbol] _{B,I}U)^{†}. |
| \| | X_{I,B} ← −U · X_{B,}X_{B,B}. |

end

| | |
|---|---|
| /* (Optional) Compute a preconditioner for \hat{L}. | */ |

Algorithm 2: FIND-ELECTRICAL-Flow(G, [symbol] , \hat{L}, X, Y, s, t)

```
input :Weighted graph G, its partitioning [symbol]   ;
  \hat{L}, X: the output of PREPROCESS-GRAPH;
  s, t: source and destination.
output: f ∈ [symbol]   ^{E}; Electrical flow from s to t.
```

| | |
|---|---|
| d ← Xs − Xt. /* original demands. | */ |
| d^{r} ← d_{∂} [symbol] . /* reduced demands. | */ |
| /* Transfer the demands to boundaries. | */ |

foreach C ∈ [symbol] with (s, t) ∩ C ≠ ∅ do

| | |
|---|---|
| \| | B ← ∂C, I ← int(C). |
| \| | d_{B}^{r} ← d_{B}^{r} − L_{B,I}L_{I,J}⁻¹d_{I}. |

end
φ ← \hat{L}ⁱd^{r}. /* Can use a preconditioner here. */
G^{b} ← G[∂ [symbol] ], E^{b} ← edges of G^{b}.
L^{b} ← Laplacian matrix of G^{b}.
d_{∂C} ← d_{∂C} − L^{b}d^{r}.

| | |
|---|---|
| f_{E}_{^{b}} ← ∇_{G}_{^{b}}φ. /* flow on intra-boundary edges. | */ |

φ ← X · d.
foreach C ∈ [symbol] with {s, t} ∩ C ≠ ∅ do

| | |
|---|---|
| \| | [symbol] ← G[C] with all edges between boundaries removed. |
| \| | [symbol] ← Laplacian matrix of [symbol] . |
| \| | φ_{C} ← [symbol] ^{†}d_{C}. |

end
/* let Eⁱ be the edges incident to any interior
node so that E = Eⁱ ∪ E^{b} and Gⁱ be the

| | |
|---|---|
| corresponding graph. | */ |

f_{E}_{ⁱ} ← ∇_{G}_{ⁱ}φ.

Algorithm 3: GENERATE-ALTERNATES(G, [symbol] , L, X, s, t, k)

| input :Weighted graph G, its partitioning [symbol] ; | |
|---|---|
| L, X: the output of PREPROCESS-GRAPH; | |
| s, t, [symbol] : source, destination and number of alternates. | |
| output : Up to [symbol] paths from s to t, II. | |
| f ← FIND-ELECTRICAL-FLOW(G, [symbol] , \hat{L}, X, s, t), II ← ∅. | |
| for 2 [symbol] times do | |
| \| | Find a path π that maximizes the minimum flow from f |
| \| | along its edges, and remove it from f and add π to II. |
| \| | If no π exists, break. |

end
Output [symbol] paths with the smallest cost (or all paths if there
are fewer than [symbol] paths).

In some embodiments, one or more steps can be parallelized. For instance, in some embodiments, all or nearly all steps can be parallelized. For instance, in some embodiments, resolving for the electrical flow f can be highly parallelized.

### Example Results

Example results are presented herein for illustrative purposes only. Particular configurations of embodiments of the present disclosure described herein for the sake of describing the example results are provided for example purposes only, and not by way of limitation.

For the present example results, Open Street Map data was used for the Bay Area region (containing San Francisco and San Jose). To run experiments on this area, the map is clipped using latitude-longitude boundaries. The weight of each edge was computed as the ratio of the edge's distance and the maximum speed along that edge. In one example, parallel edges were eliminated to form an undirected graph. The resulting graph contained 2.73M nodes and 2.93M edges. The Inertial Flow algorithm with balancedness parameter 0.1 was used to compute a partitioning of the graph with the partition sizes between 250 and 500. There were 9.3K components in the partitioning. The matrices \hat{L}, X, and Y generated by Algorithm 1 above had nnz(\hat{L})=615K, nnz(X)=19.3M, and nnz(Y)=18.7M non-zero entries, respectively.

For simulated queries, 200 source-destination pairs from 10 km up to a distance of 100 km were sampled while making sure that the distribution of distances was uniform. For each pair, 20 and 100 alternative paths were generated.

For solution of the linear system(s), a Preconditioned Conjugate Gradient algorithm was used with an incomplete Cholesky factorization preconditioner with thresholding, where the drop threshold was set to 10⁻⁷. A four-way heap was used to implement Dijkstra.

For baselines, the naïve penalty method and the plateau method are provided. In the penalty method, in each iteration, a shortest path is chosen, and the weight of all edges along and incident to that path are increased by a factor of β=1.20. Pruning restricted the search space to only nodes u such that d(s,u)+d(u,t)≤Δ₀d (s,t) for Δ₀=2. It was seen that pruning of this sort has little to no effect as the distances increase. Generally, with this prior technique, in order to obtain good results, the penalty parameter needs to be made smaller; however smaller values of β make the algorithm prohibitively slow. Even with reasonably high penalty values, this method is quite slow: After each update, it is necessary to run a full Dijkstra. Since the graph keeps changing between iterations, it is not possible to speed up this step using any of the known preprocessing techniques.

In the plateau method baseline, a forward shortest path tree is constructed from the source and a backward shortest path tree from the destination. All edges present in both of the trees are called plateau edges. Note that each plateau edge defines a unique path from source to sink in the union of these two trees. Next all plateau edges are sorted with respect to the length of the corresponding source-destination path. Each such path is added to the set of alternates as long as its minimum Jaccard distance with any of the found paths is greater than some threshold a. If the method fails to produce the desired number of alternates, the threshold is decreased and the method is repeated. For the baseline experiments, the thresholds used are {0.3, 0.2, 0.1}. To speed up the algorithm, after an edge is considered, the preceding and proceeding 50 edges in the forward and backward trees are removed from further consideration. Generally, the alternates produced by plateau method tend to be very similar to each other; it cannot find a reasonable number of alternates if the threshold is set high; if there are not enough alternates for the given similarity threshold, plateau method will run very slow as nearly all the plateau edges need to be expanded; and, when the source and destination both are very close to a shortcut road (such as a highway), all the alternates will be using that shortcut road.

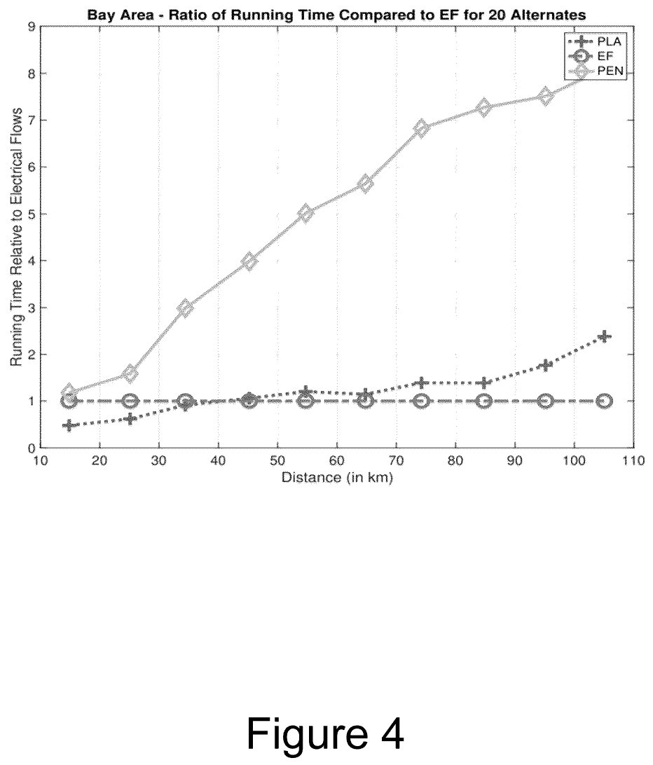

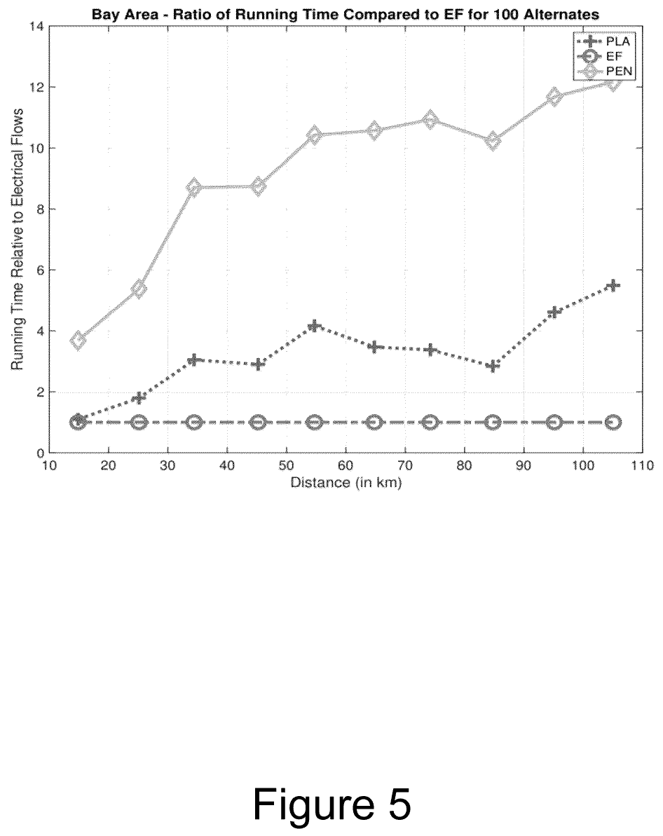

FIG. 4 depicts a chart providing running time comparisons between an Example Embodiment (EF), the plateau baseline (PLA), and penalty baseline (PEN) methods. For each source-destination pair, the ratio of running times for PLA and PEN against EF for generating 20 alternates are provided. Since the algorithms exhibit different run-time behavior with respect to the distances, the ratio of running times is averaged over 10 km buckets. FIG. 5 depicts a chart for generating 100 alternates.

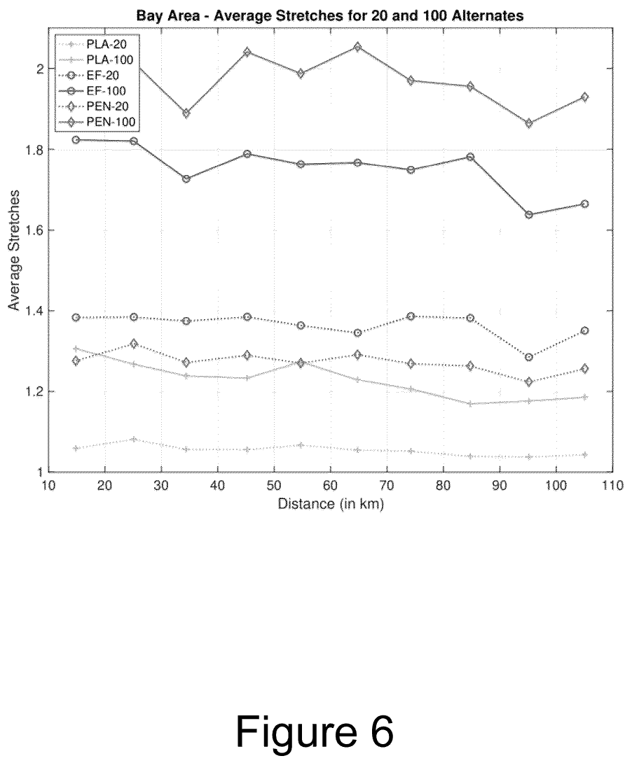

The quality of the generated alternatives is evaluated using three different quantities. One natural consideration for any alternative path generation algorithm is that the produced alternates should not be much worse than the shortest path. This can be quantified by measuring the stretch of each path, which is the ratio of path's cost to the shortest path cost. Stretches are given in FIG. 6 for 20 and 100 alternates.

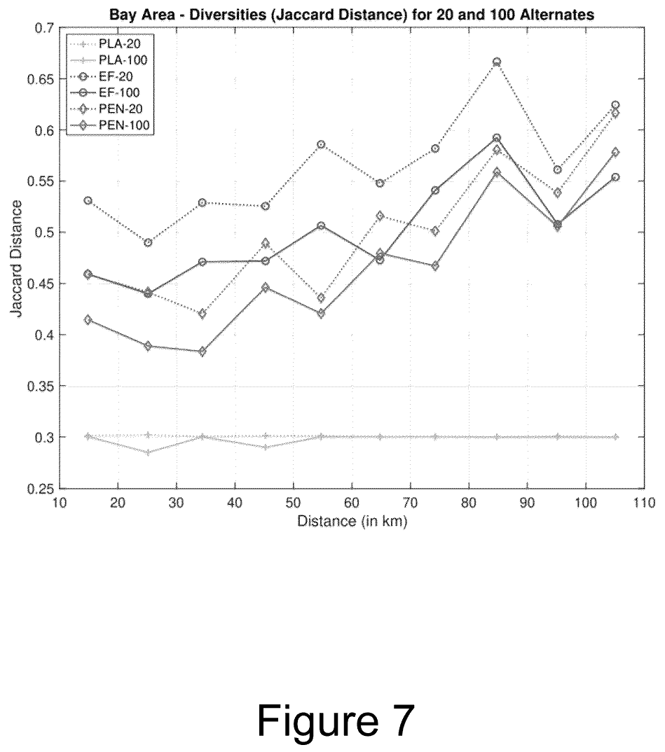

Another desirable aspect from alternative paths is that each path should be sufficiently different from the preceding ones. For this aspect, one metric to quantify can be the Jaccard distance, J (A,B):=|AΔB∥A∪B|, where AΔB is the symmetric set difference. For each path record the minimum Jaccard distance to the preceding paths. The diversity results for 20 and 100 alternates are given in FIG. 7.

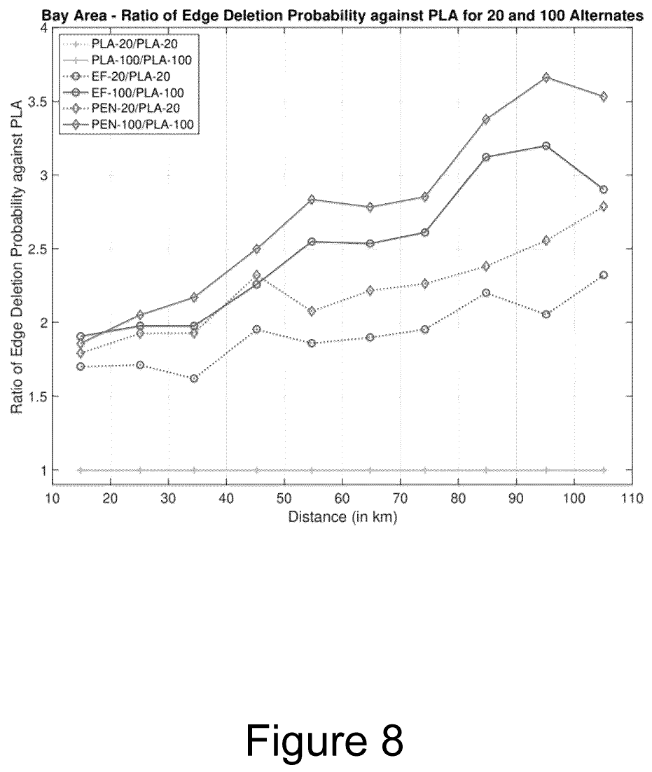

Another desirable aspect is robustness. One failure model is random edge deletion. What fraction of the edges can be deleted independently at random and still allow for the set of alternatives to provide a path from source to destination? The maximum fraction of edges that can be randomly deleted before the probability of t being unreachable from s can provide an indication. For the present experiments, the following approximation algorithm for ρ (averaged over 30 runs) was used: (1) Choose a random ordering of the edges, o:E→Z. (2) Find the path that maximizes the minimum oₑ along its edges in the directed alternates graph. Let o* be this value and output o*/|E|. The relative robustness probabilities with respect to PLA are provided in FIG. 8.

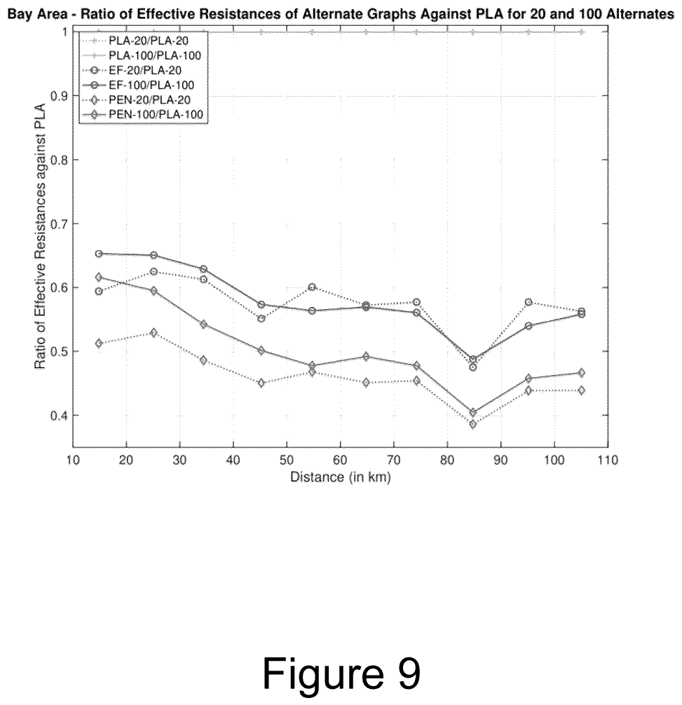

Effective resistance itself can also be used as a robustness measure. It is a complex function of the network that considers different routes from s to t, their stretches and overlaps. For example, in a graph where there is a single path from s to t of length k, the s-t effective resistance will be k, whereas if there are k parallel paths of length 10k, the effective resistance will be 10. So, a lower effective resistance can indicate a more robust alternates graph. Results for 20 and 100 alternate paths can be found in FIG. 9. The results are given as ratios against PLA, whose alternates always had the highest effective resistance.

### Example Devices and Systems

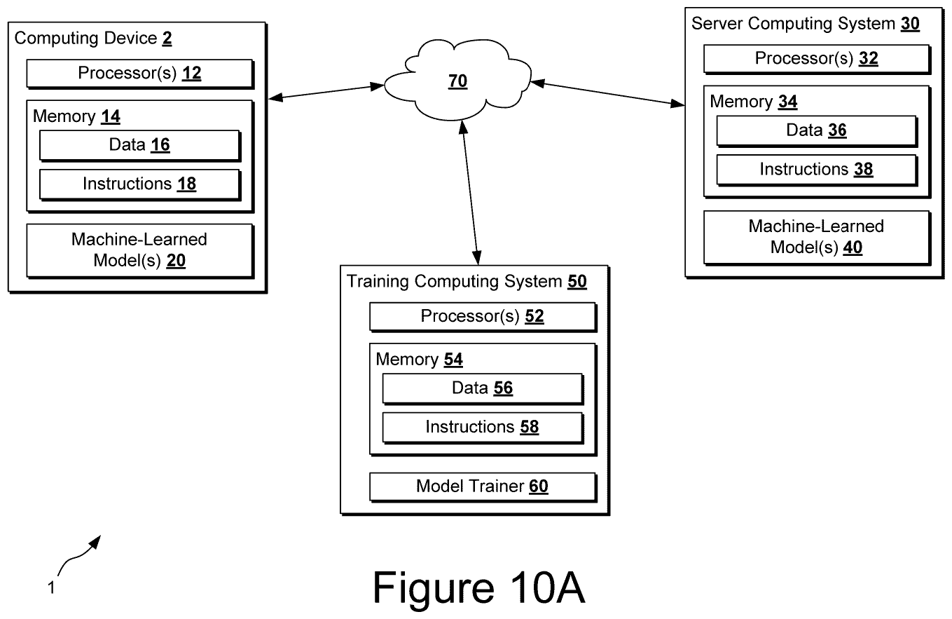

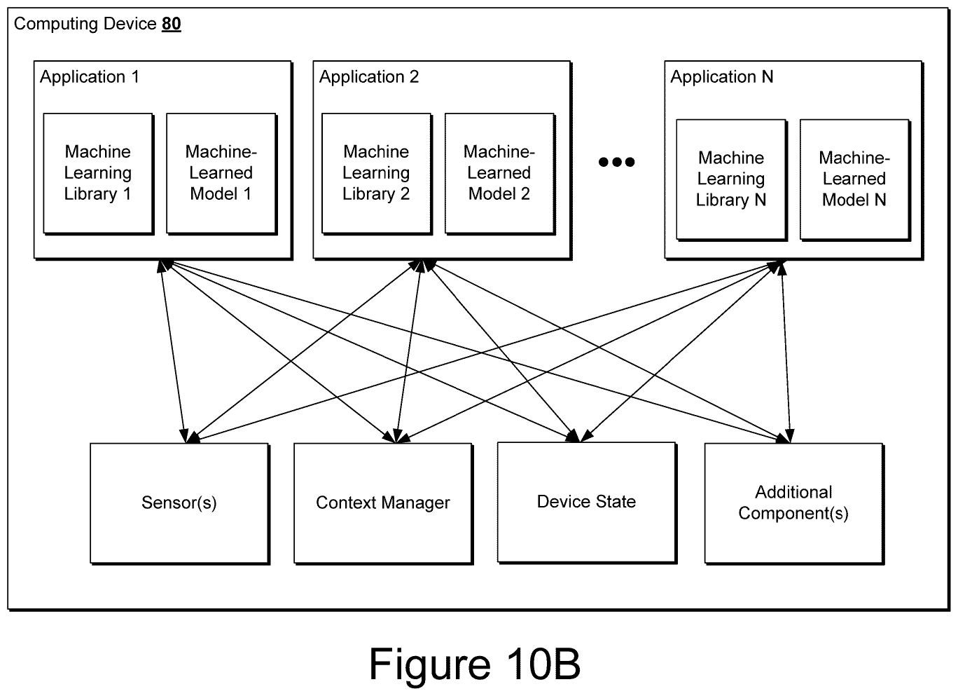

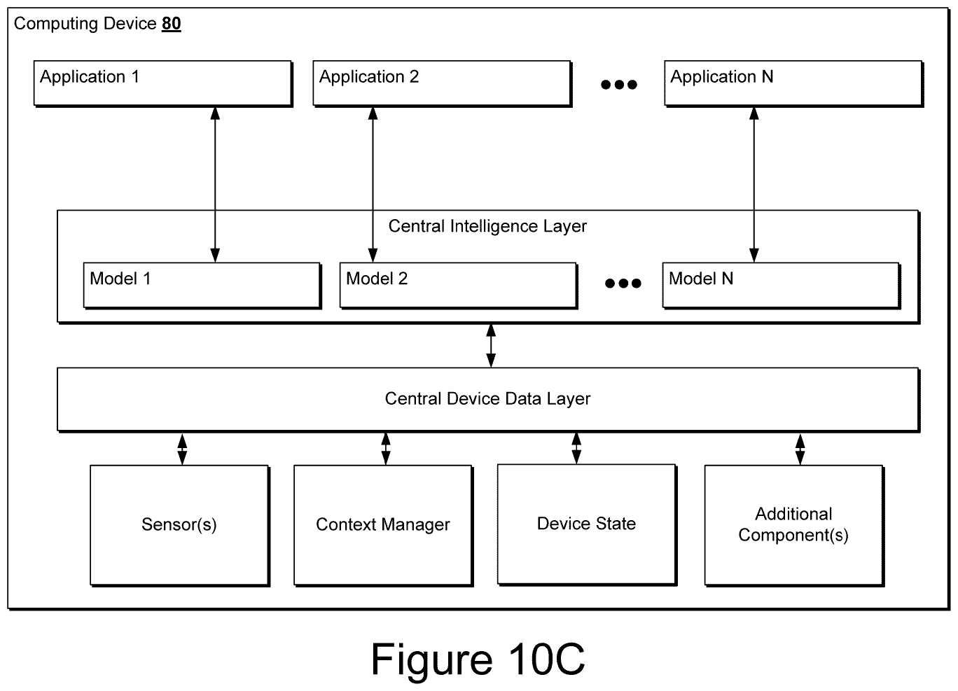

FIG. 10A depicts a block diagram of an example computing system 1 that can generate or implement alternative paths generation according to example embodiments of the present disclosure. The system 1 includes a computing device 2, a server computing system 30, and a training computing system 50 that are communicatively coupled over a network 70.

The computing device 2 can be any type of computing device, such as, for example, a personal computing device (e.g., laptop or desktop), a mobile computing device (e.g., smartphone or tablet), a gaming console or controller, a wearable computing device, an embedded computing device, or any other type of computing device. In some embodiments, the computing device 2 can be a client computing device. The computing device 2 can include one or more processors 12 and a memory 14. The one or more processors 12 can be any suitable processing device (e.g., a processor core, a microprocessor, an ASIC, an FPGA, a controller, a microcontroller, etc.) and can be one processor or a plurality of processors that are operatively connected. The memory 14 can include one or more non-transitory computer-readable storage media, such as RAM, ROM, EEPROM, EPROM, flash memory devices, magnetic disks, etc., and combinations thereof. The memory 14 can store data 16 and instructions 18 which are executed by the processor 12 to cause the user computing device 2 to perform operations (e.g., to perform operations generating alternative paths according to example embodiments of the present disclosure, etc.).

In some implementations, the user computing device 2 can store or include one or more machine-learned models 20. For example, the machine-learned models 20 can be or can otherwise include various machine-learned models such as neural networks (e.g., deep neural networks) or other types of machine-learned models, including non-linear models or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, one or more machine-learned models 20 can be received from the server computing system 30 over network 70, stored in the computing device memory 14, and used or otherwise implemented by the one or more processors 12. In some implementations, the computing device 2 can implement multiple parallel instances of a machine-learned model 20.

Additionally, or alternatively, one or more machine-learned models 40 can be included in or otherwise stored and implemented by the server computing system 30 that communicates with the computing device 2 according to a client-server relationship.

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some embodiments, the machine-learned models 40 can be implemented by the server computing system 40 as a portion of a web service (e.g., remote machine-learned model hosting service, such as an online interface for performing machine-learned model operations over a network on remote servers 30). For instance, the server computing system 30 can communicate with the computing device 2 over a local intranet or internet connection. For instance, the computing device 2 can be a workstation or endpoint in communication with the server computing system 30, with implementation of the model 40 on the server computing system 30 being remotely performed and an output provided (e.g., cast, streamed, etc.) to the computing device 2. Thus, one or more models 20 can be stored and implemented at the user computing device 2 or one or more models 40 can be stored and implemented at the server computing system 30.

The computing device 2 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 30 can include one or more processors 32 and a memory 34. The one or more processors 32 can be any suitable processing device (e.g., a processor core, a microprocessor, an ASIC, an FPGA, a controller, a microcontroller, etc.) and can be one processor or a plurality of processors that are operatively connected. The memory 34 can include one or more non-transitory computer-readable storage media, such as RAM, ROM, memory 34 can store data 36 and instructions 38 which are executed by the processor 32 to cause the server computing system 30 to perform operations (e.g., to perform operations implementing alternative path generation according to example embodiments of the present disclosure, etc.).

In some implementations, the server computing system 30 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 30 can store or otherwise include one or more machine-learned models 40. For example, the models 40 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The computing device 2 or the server computing system 30 can train example embodiments of a machine-learned model (e.g., including models 20 or 40) using a pretraining pipeline (e.g., an unsupervised pipeline, a semi-supervised pipeline, etc.). In some embodiments, the computing device 2 or the server computing system 30 can train example embodiments of a machine-learned model (e.g., including models 20 or 40) using a pretraining pipeline by interaction with the training computing system 50. In some embodiments, the training computing system 50 can be communicatively coupled over the network 70. The training computing system 50 can be separate from the server computing system 30 or can be a portion of the server computing system 30.

The training computing system 50 can include one or more processors 52 and a memory 54. The one or more processors 52 can be any suitable processing device (e.g., a processor core, a microprocessor, an ASIC, an FPGA, a controller, a microcontroller, etc.) and can be one processor or a plurality of processors that are operatively connected. The memory 54 can include one or more non-transitory computer-readable storage media, such as RAM, ROM, memory 54 can store data 56 and instructions 58 which are executed by the processor 52 to cause the training computing system 50 to perform operations (e.g., to perform operations generating alternative paths according to example embodiments of the present disclosure, etc.). In some implementations, the training computing system 50 includes or is otherwise implemented by one or more server computing devices.

The model trainer 60 can include a pretraining pipeline for training machine-learned models using various objectives. Parameters of the image-processing model(s) can be trained, in some embodiments, using various training or learning techniques, such as, for example, backwards propagation of errors. For example, an objective or loss can be backpropagated through the pretraining pipeline(s) to update one or more parameters of the model(s) (e.g., based on a gradient of the loss function). Various determinations of loss can be used, such as mean squared error, likelihood loss, cross entropy loss, hinge loss, or various other loss functions. Gradient descent techniques can be used to iteratively update the parameters over a number of training iterations. In some implementations, performing backwards propagation of errors can include performing truncated backpropagation through time. The pretraining pipeline can perform a number of generalization techniques (e.g., weight decays, dropouts, etc.) to improve the generalization capability of the models being trained.

The model trainer 60 can include computer logic utilized to provide desired functionality. The model trainer 60 can be implemented in hardware, firmware, or software controlling a general-purpose processor. For example, in some implementations, the model trainer 60 includes program files stored on a storage device, loaded into a memory, and executed by one or more processors. In other implementations, the model trainer 60 includes one or more sets of computer-executable instructions that are stored in a tangible computer-readable storage medium such as RAM, hard disk, or optical or magnetic media.

The network 70 can be any type of communications network, such as a local area network (e.g., intranet), wide area network (e.g., Internet), or some combination thereof and can include any number of wired or wireless links. In general, communication over the network 70 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

FIG. 10A illustrates one example computing system that can be used to implement the present disclosure. Other computing systems can be used as well. For example, in some implementations, the computing device 2 can include the model trainer 60. In some implementations, the computing device 2 can implement the model trainer 60 to personalize the model(s) based on device-specific data.

FIG. 10B depicts a block diagram of an example computing device 80 that performs according to example embodiments of the present disclosure. The computing device 80 can be a user computing device or a server computing device. The computing device 80 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 9B, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 10C depicts a block diagram of an example computing device 80 that performs according to example embodiments of the present disclosure. The computing device 80 can be a user computing device or a server computing device. The computing device 80 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 10C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 80.

The central intelligence layer can communicate with a central device data layer. The central device data layer can be a centralized repository of data for the computing device 80. As illustrated in FIG. 10C, the central device data layer can communicate with a number of other components of the computing device, such as, for example, one or more sensors, a context manager, a device state component, or additional components. In some implementations, the central device data layer can communicate with each device component using an API (e.g., a private API).

### Example Methods

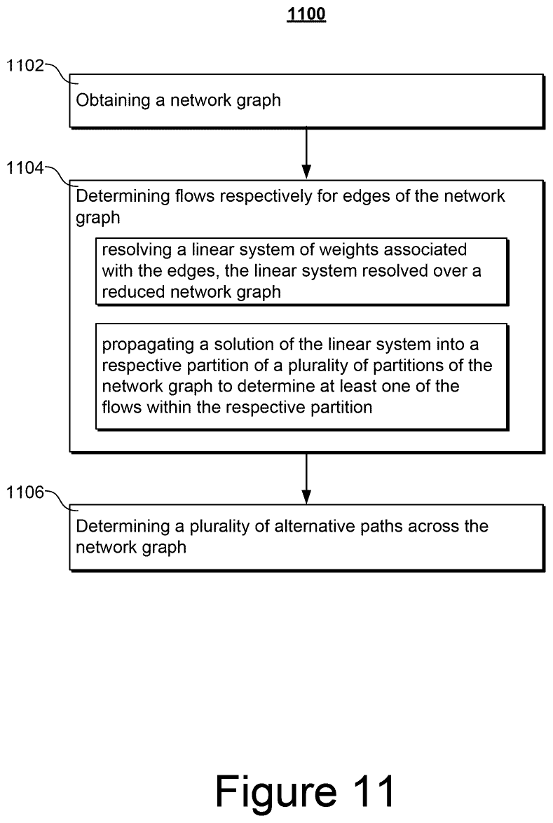

FIG. 11 depicts a flow chart diagram of an example method 1100 to perform according to example embodiments of the present disclosure. Although FIG. 11 depicts steps performed in a particular order for purposes of illustration and discussion, the methods of the present disclosure are not limited to the particularly illustrated order or arrangement. The various elements of the method 1100 can be omitted, rearranged, combined, and/or adapted in various ways without deviating from the scope of the present disclosure.

At 1102, example method 1100 can include obtaining a network graph. In various embodiments, the network graph can be descriptive of substantially any networked system. For instance, the network graph can be descriptive of a road network, a computer network, a logistics network, an electrical grid, a graph neural network, etc. In general, the network graph can include nodes and edges. In some embodiments, the nodes or edges can be assigned weights or other values. For instance, a weight can be associated with a cost or reward for traversing an edge or passing through a node when charting a path across the network graph. For instance, in the context of a road network, a weight can be associated with a distance of a road segment (e.g., between intersections, etc.), a throughput of a road segment (e.g., based on number of lanes, speed limit, etc.), and the like.

At 1104, example method 1100 can include determining flows across the network graph. For instance, flows can be determined respectively for edges of the network graph by resolving a linear system of weights associated with the edges. For instance, flows can be determined respectively for edges of the network graph by propagating a solution of the linear system into a respective partition of a plurality of partitions of the network graph to determine at least one of the flows within the respective partition.

For example, the flows over the network graph can be simulated as electrical flows under load. For instance, a simulated “source” and “sink” representing different electrical potentials can be injected into the graph (e.g., at a node) to simulate demands on the network graph, with one or more weights of the network graph corresponding to resistances or conductances. In some embodiments, the electrical flows can be modeled using a linear system, such that a linear system of the network graph weights can be resolved to obtain the flows over the graph (e.g., by obtaining the potentials at each node, by obtaining the flows directly, etc.). In some embodiments, the linear system can be resolved over a reduced network graph. For instance, a reduced network graph can be obtained to decrease a computational cost (e.g., compute, time, etc.) of resolving the system according to example embodiments of the present disclosure.

At 1106, example method 1100 can include determining a plurality of alternative paths across the network graph. For instance, an “optimal” path may be obtained, but a single path may be more susceptible to network fault than a set of alternatives. Thus, a plurality of alternative paths can be obtained for robust routing across the network graph. For instance, for a given fault condition on the network graph, the plurality of alternative paths can provide at least one alternative path unbroken by the fault condition.

In some embodiments, determining the flows (e.g., at 1104) can include partitioning the network graph into a plurality of subgraphs and generating, using a node elimination transform, a plurality of equivalent subgraphs respectively for the plurality of subgraphs. For instance, a node elimination transform can include a Gaussian elimination operations, a Schur complement, etc. for generating a subgraph that provides for equivalent flows through the remaining nodes. For instance, a respective boundary of a respective subgraph of the plurality of subgraphs can be associated with one or more network bottlenecks. And generating a respective equivalent subgraph for the respective subgraph can include eliminating one or more internal nodes of the respective subgraph (e.g., using a star-mesh reduction, etc.) and connecting at least two of the one or more network bottlenecks. In this manner, for instance, the network bottlenecks can be retained and connected to form an equivalent subgraph that provides for equivalent flows across the partition boundaries. In some embodiments, a reduced subgraph of the network graph can be formed from the equivalent subgraph(s) so that the linear system can be resolved over the reduced subgraph.

In some embodiments, example method 1100 can include recovering one or more flows within at least one subgraph of the plurality of subgraphs using an interpolation transform. For instance, an interpolation transform can provide a flow mapping to the at least one subgraph from at least one equivalent subgraph respectively corresponding to the at least one subgraph. For instance, an equivalent subgraph can contain interconnected bottleneck nodes, and it may be of interest to obtain a potential of one or more nodes that were eliminated in forming the equivalent subgraph (e.g., for computing a flow across one or more edges therebetween). The interpolation transform can provide for computing the potentials of the eliminated interior node(s) based on the potentials/flows across the bottleneck nodes. In some embodiments, the interpolation transform is precomputed. For example, partitioning and precomputation of the interpolation transform can occur prior to receipt of a runtime query (e.g., a request for one or more network paths or routes).

In some embodiments, the plurality of subgraphs correspond to a hierarchical structure having a plurality of scales, with one or more subgraphs of the plurality of subgraphs associated with each of the plurality of scales. For instance, a map of a road system may include many regions arranged in a hierarchy based on length scales. For instance, a map of the United States can be subdivided into regions, states, counties, cities, etc. In some embodiments, partitioning and solution can occur over multiple scales to provide for pruning of the network graph at different precisions. For instance, a solution over a reduced subgraph at a first level (e.g., largest distance scale) may provide for coarse pruning of the network graph, while a subsequent second solution over a reduced subgraph at a second level (e.g., a smaller distance scale) may provide for finer pruning of the network graph. In some embodiments, a network graph can be partitioned at a plurality of scales, interpolation transforms can be precomputed for the subgraphs at each scale, and the linear system can be resolved a plurality of times over the reduced subgraphs at the various scales to refine the search space. In some embodiments, the linear system can be resolved in order of decreasing scale.

In some embodiments, determining the plurality of alternative paths (e.g., at 1106) can include an iterative technique. For instance, for a plurality of iterations, the example method 1100 can include determining a candidate path having a flow amount, adding the candidate path to the plurality of alternative paths, and removing the flow amount from a total flow. In this manner, for example, building a set of alternatives based on flow decomposition can provide for increased diversity of flow paths. In some embodiments, the candidate paths are determined in order of decreasing flow amount.

In some embodiments, determining the plurality of alternative paths (e.g., at 1106) can include a multi-stage technique. For instance, in some embodiments, determining the plurality of alternative paths can include implementing a penalty-type approach over a subgraph intelligently pruned using the electrical-flow based techniques of the present disclosure. For instance, in some embodiments, determining the plurality of alternative paths can include determining a candidate subgraph comprising one or more flows greater than a threshold. Using the candidate subgraph, an iterative penalty-type approach can be applied. For instance, in some embodiments, the example method 1100 can include, for a plurality of iterations, determining a candidate path through the candidate subgraph having costs respectively associated with one or more path segments along the candidate path, adding the candidate path to the plurality of alternative paths, increasing the costs. In some embodiments, the candidate paths are determined in order of increasing cost.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Also, terms such as “based on” should be understood as “based at least in part on.”

What is claimed is:

1. A computer-implemented method for generating alternative network paths, the method comprising:
obtaining, by a computing system comprising one or more processors, a network graph;
determining, by the computing system, flows respectively for edges of the network graph by:
resolving a linear system of weights associated with the edges, the linear system resolved over a reduced network graph, and
propagating a solution of the linear system into a respective partition of a plurality of partitions of the network graph to determine at least one of the flows within the respective partition; and
determining, by the computing system and based on the flows, a plurality of alternative paths across the network graph.

2. The computer-implemented method of claim 1, wherein determining the flows comprises:
partitioning, by the computing system, the network graph into the plurality of subgraphs; and
generating, by the computing system and using a node elimination transform, a plurality of equivalent subgraphs respectively for the plurality of subgraphs;
wherein the linear system is resolved over the plurality of equivalent subgraphs.

3. The computer-implemented method of claim 2, wherein a respective boundary of a respective subgraph of the plurality of subgraphs is associated with one or more network bottlenecks.

4. The computer-implemented method of claim 3, wherein generating a respective equivalent subgraph for the respective subgraph comprises:
eliminating, by the computing system, one or more internal nodes of the respective subgraph; and
connecting, by the computing system, at least two of the one or more network bottlenecks.

5. The computer-implemented method of claim 4, wherein the one or more internal nodes are eliminated using a star-mesh reduction.

6. The computer-implemented method of claim 2, comprising:
recovering, by the computing system, one or more flows within at least one subgraph of the plurality of subgraphs using an interpolation transform;
wherein the interpolation transform provides a flow mapping to the at least one subgraph from at least one equivalent subgraph respectively corresponding to the at least one subgraph.

7. The computer-implemented method of claim 6, wherein the interpolation transform is precomputed.

8. The computer-implemented method of claim 2, wherein the plurality of subgraphs correspond to a hierarchical structure having a plurality of scales, with one or more subgraphs of the plurality of subgraphs associated with each of the plurality of scales, and wherein the linear system is resolved in order of decreasing scale.

9. The computer-implemented method of claim 1, wherein the network graph corresponds to a road system.

10. The computer-implemented method of claim 9, wherein the flows correspond to traffic flows.

11. The computer-implemented method of claim 1, wherein, for a given fault condition on the network graph, the plurality of alternative paths provide at least one alternative path unbroken by the fault condition.

12. The computer-implemented method of claim 1, wherein determining the plurality of alternative paths comprises:
for a plurality of iterations:
determining, by the computing system, a candidate path having a flow amount;
adding, by the computing system, the candidate path to the plurality of alternative paths; and
removing, by the computing system, the flow amount from a total flow.

13. The computer-implemented method of claim 12, wherein the candidate paths are determined in order of decreasing flow amount.

14. The computer-implemented method of claim 1, wherein determining the plurality of alternative paths comprises:
determining, by the computing system, a candidate subgraph comprising one or more flows greater than a threshold; and
for a plurality of iterations:
determining, by the computing system, a candidate path through the candidate subgraph having costs respectively associated with one or more path segments along the candidate path;
adding, by the computing system, the candidate path to the plurality of alternative paths; and
increasing, by the computing system, the costs.

15. The computer-implemented method of claim 14, wherein the candidate paths are determined in order of increasing cost.

16. A system for generating alternative network paths, the system comprising:
one or more processors; and
one or more memory devices storing non-transitory computer-readable instructions that are executable to cause the one or more processors to perform operations, the operations comprising:
obtaining a network graph comprising a plurality of nodes and a plurality of edges disposed therebetween;
determining a plurality of reduced subgraphs respectively corresponding to a plurality of subgraphs of the network graph, a respective reduced subgraph comprising one or more boundary nodes of a respective subgraph;
generating a plurality of interpolation transforms respectively for the plurality of subgraphs, a respective interpolation transform mapping demands on the one or more boundary nodes of the respective subgraph to internal nodes of the respective subgraph;
obtaining a query indicating a load on the network graph corresponding to a source and a sink;
determining, based on the load, an equivalent load on the plurality of reduced subgraphs; and
determining, based on flows induced in the plurality of reduced subgraphs by the equivalent load, a candidate subgraph of the network graph comprising a plurality of alternative paths.

17. The system of claim 16, wherein determining the candidate subgraph comprises:
pruning edges of the network graph corresponding to a flow below a threshold.

18. The system of claim 16, wherein the plurality of reduced subgraphs are determined using a star-mesh reduction.

19. The system of claim 16, wherein the operations comprise, for a plurality of iterations:
determining a candidate path through the candidate subgraph having costs respectively associated with one or more path segments along the candidate path;
adding the candidate path to the plurality of alternative paths; and
increasing the costs.

20. One or more memory devices storing non-transitory computer-readable instructions that are executable to cause one or more processors to perform operations, the operations comprising:
obtaining a query indicating a load on a network graph corresponding to a source and a sink;
determining, based on the load, an equivalent load on a plurality of reduced subgraphs; and
determining, based on flows induced in the plurality of reduced subgraphs by the equivalent load, a candidate subgraph of the network graph comprising a plurality of alternative paths, wherein the flows are recovered using a plurality of interpolation transforms respectively associated with the plurality of reduced subgraphs.
